(19) United States
(12) Patent Application Publication
(10) Pub. No.: US 2009/0321432 A1
(43) Pub. Date: Dec. 31, 2009

(54) Apparatus for Processing a Wafer

(76) Inventors: II-Young Han, Uiwang-si (KR); Mitsuo Umemoto, Seongnam-si (KR); Ki-Kwon Jeong, Cheonan-si (KR); Won-Keun Kim, Hwaseong-si (KR)

Correspondence Address: F. CHAU & ASSOCIATES, LLC, 130 WOODBURY ROAD, WOODBURY, NY, 11797, US

(21) Appl. No.: 12/492,760

(22) Filed: Jun. 26, 2009

(30) Foreign Application Priority Data
Jun. 30, 2008 (KR) 2008-62457

(51) Int. Cl. H05B 6/64

(52) U.S. Cl. 219/761

(57) ABSTRACT

An apparatus for processing a wafer includes a chamber, a boat, microwave generators and reflective plates. The boat is disposed in the chamber. One or more wafers are stacked in the boat. One or more microwave generators are connected to the chamber. The microwave generators generate microwaves for heating the wafers. The reflective plates reflect the microwaves onto the wafers such that the microwaves are uniformly applied to the wafers. Each of the reflective plates faces at least one of both sides of the wafer. The reflective plates include at least one of a fat side, a concave side and a convex side.

### CROSS-REFERENCE TO RELATED APPLICATION

This application claims priority to and the benefit of Korean Patent Application No. 2008-62457, filed on Jun. 30, 2008 in the Korean Intellectual Property Office (KIPO), the entire content of which is incorporated bid reference herein.

### BACKGROUND

1. Field of the Invention

The present disclosure relates semiconductor manufacturing equipment, and, more particularly, to an apparatus for processing a wafer.

2. Discussion of the Related Art

Generally, semiconductor devices are manufactured by sequentially performing a series of unit processes, namely, individual steps to produce finished goods. The unit processes include a deposition process for forming a layer on a wafer, a photo process for forming a photoresist pattern on the layer, an etching process for patterning the layer into a pattern having electrical characteristics using the photoresist pattern, a chemical mechanical polishing (CMP) process or an etch-back process for planarizing the layer, an ion implantation process for implanting ions into portions of the wafer, a cleaning process for removing particles from the wafer, an inspection process for inspecting defects of the layer and the pattern, etc.

Some of the unit processes require a heating step for heating the wafer. In an exemplary embodiment, the photo process requires the heating step for hardening the photoresist pattern on the wafers, and (he deposition process and the etching process need the heating step for an efficient chemical reaction of process gases.

In a conventional apparatus for processing a wafer (hereinafter referred to as a process apparatus), a plurality of the wafers are vertically stacked as a bundle in the process apparatus and microwaves are applied to the wafer bundle for heating the wafers. When the wafers are closely packed in the bundle and a gap distance between the wafers is very small, the microwaves hardly reach a central portion of the wafer, and thus most of the microwaves are applied to an edge portion of the wafers. Therefore, the temperature of the edge portion of each wafer becomes much higher than that of the center portion of each wafer, and thus the edge portion of the wafer is intensively heated in the conventional process apparatus. As a result, the temperature distribution of each wafer may not be uniform in the conventional process apparatus.

Further, the microwaves are generally reflected from a chamber wall in the process apparatus and most of the reflected microwaves are applied to a topmost wafer and to a bottommost wafer in the wafer bundle and the reflected microwaves are hardly applied to middle wafers between the topmost and the bottommost wafers in the wafer bundle. Hence, the temperature of the topmost and bottommost wafers becomes higher than that of the middle wafers, and thus the wafer temperature may not be uniform along a vertical direction in the wafer bundle.

Accordingly, the non-uniformity of the wafer temperature can cause many process defects in the conventional process apparatus such as non-uniform curing of a layer on the wafer, non-uniform hardening of a photoresist pattern on the wafer, non-uniform deposition of a layer on the wafer and non-uniform etching against a layer on the wafer.

### SUMMARY

According to an exemplary embodiment of the present invention, an apparatus for processing a wafer to uniformly heat and process the wafer is provided.

According to an exemplary embodiment, an apparatus for processing a wafer includes a chamber; a boat in the chamber, a plurality of the wafers being stackable in the boat; a plurality of microwave generators connected to the chamber, the microwave generator configured to generate microwaves that heat the wafers; and a plurality of reflective plates from which the microwaves are reflected onto the wafers such that the microwaves are uniformly applied to the wafers.

Each of the reflective plates may face at least one of both sides of the wafer.

The reflective plates may include at least one of a flat side, a concave side or a convex side.

A diameter of the reflective plate may be greater than or equal to a diameter of the wafer.

The apparatus may further include a plurality of power supplies connected to the generators, respectively, that supply output power to the microwave generator; and a controller connected to the power supplies that controls generation of the microwaves by turning on or off the power supplies and that controls wave intensity of the microwaves by varying the output power of the power supplies, such that the microwaves are uniformly applied to the wafer.

The apparatus may further include a temperature sensor positioned at an upper portion of an inside of the chamber and connected to the controller, such that a temperature of the wafer is detected through a hole penetrating a central portion of an uppermost reflective plate by the temperature sensor and the controller controls the power supplies in accordance with the detected temperature of the wafer.

The controller may maintain a total sum of the output power of the power supplies to be constant.

The apparatus may further include a driving unit connected to the boat and including a motor for rotating the boat and for linearly moving the boat in a vertical direction and in a horizontal direction.

The apparatus may further include a gas supply line connected to the chamber, the gas supply line supplying a processing gas for processing the wafers in the chamber.

The processing gas may include one of a deposition gas for forming a layer on the wafer and an etching gas for removing a layer from the wafer.

According to an exemplary embodiment a wafer heating apparatus includes a wafer support structure configured to align one or more wafers substantially parallel to a microwave propagation direction from one or more microwave generators; and a reflective plate located adjacent to at least one wafer of the one or more wafers, the reflective plate having a surface configured to redirect to an interior portion of the at least one wafer microwaves that are generated from the one or more microwave generators and that are incident upon the reflective plate.

The reflective plate may include a first surface proximal to a wafer surface of the at least one wafer; and a second surface distal from the wafer surface, wherein the first surface is convex relative to the wafer surface and the second surface is substantially parallel to the wafer surface.

The reflective plate may include a first surface proximal to a wafer surface of the at least one wafer; and a second surface distal from the wafer surface, wherein the first surface is concave relative to the wafer surface and the second surface is substantially parallel to the wafer surface.

The reflective plate may include a first surface proximal to a wafer surface of the at least one wafer; and a second surface distal from the wafer surface, wherein both the first surface and the second surface are convex relative to the wafer surface.

The reflective plate may include a first surface proximal to a wafer surface of the at least one wafer; and a second surface distal from the wafer surface, wherein both the first surface and the second surface are concave relative to the wafer surface.

The at least one wafer may include a first wafer surface and a second wafer surface opposing the first wafer surface. The reflective plate may be adjacent the first wafer surface and a second reflective plate, having a surface configured to redirect to an interior portion of the at least one wafer microwaves incident upon the second reflective plate that are generated from the one or more microwave generators and that are incident upon the second reflective plate, may be adjacent the second wafer surface.

The wafer support structure may include a plurality of support members substantially parallel to an axis of the at least one wafer, the support members being separated from each other such that the microwaves propagate from the microwave generators into a separation area between at least one pair of adjacent support members.

Each of the support members may include a notch into which an edge of the at least one wafer is disposed.

The wafer heating apparatus may further include an end plate coupled to an edge of the support members and a drive unit coupled to the end plate, the drive unit includes one or more motors configured to move the one or more wafers in a plurality of directions relative to the microwave propagation direction.

The wafer heating apparatus may further include a controller that controls the driving unit and/or the one or more microwave generators and a sensor disposed proximal to one wafer of the at least one or more wafers and configured to provide temperature data of the one wafer to the controller for moving the at least one or more wafers and/or for regulating an amount of power generated from the one or more microwave generators.

Since in accordance with exemplary embodiments of the present invention the wafers can be uniformly heated, the process temperature of a wafer heating process can be lowered and the process time of the wafer heating process can be reduced.

### BRIEF DESCRIPTION OF THE DRAWINGS

Exemplar embodiments will be more clearly understood from the following detailed description taken in conjunction with the accompanying drawings, wherein:

FIG. 1 is a sectional view illustrating an apparatus for processing a wafer in accordance Kith an exemplary embodiment;

FIG. 2 is a partially enlarged sectional view illustrating the boat of the process apparatus illustrated in FIG. 1; and

FIGS. 3. 4, 5, 6, 7 and 8 are cross-sectional views illustrating various reflective plates in accordance with exemplar embodiments.

### DETAILED DESCRIPTION OF THE EXEMPLARY EMBODIMENTS

Various exemplary embodiments will be described more fully hereinafter with reference to the accompanying drawings. Exemplary embodiments can, however, take many different forms and should not be construed as limited to the particular exemplary embodiments set forth herein. In the drawings, the sizes and relative sizes of elements and regions may be exaggerated for clarity.

It will be understood that when an element or component is referred to as being “on,” “connected to” or “coupled to” another element or component, it can be directly on, connected or coupled to the other element or layer or intervening elements or component may be present.

It will be understood that, although the terms first, second, third, etc. may be used herein to describe various elements, components, regions, and/or sections, these elements, components, regions, and/or sections should not be limited by these terms. These terms are merely used to distinguish one element, component, region, or section from another element, component, region, or section. Thus, a first element, component, region, or section discussed below could be termed a second element, component, region, or section without departing from the teachings brought forth by the exemplary embodiments of the present invention.

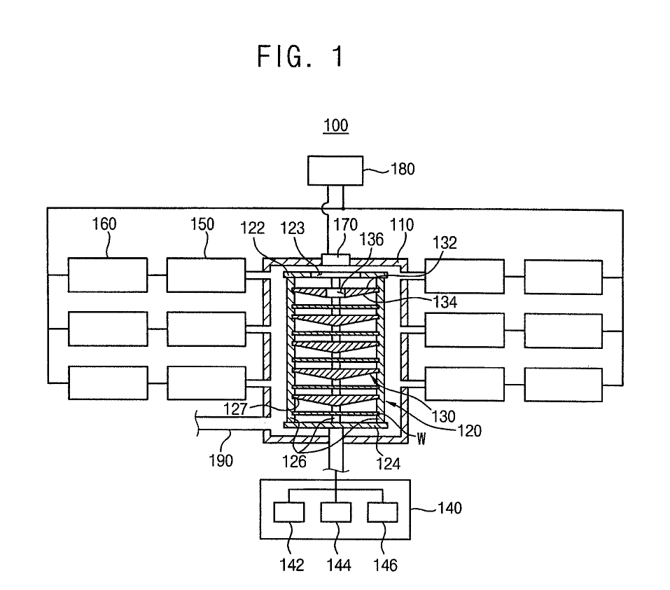

FIG. 1 is a cross-sectional view illustrating an apparatus for processing a wafer in accordance with exemplary embodiments. The apparatus for processing a wafer (the process apparatus) 100 includes a chamber 110, a boat 120, reflective plates 130, a driving unit 140, microwave generators 150, power supplies 160, a sensor 170, a controller 180, and a gas supply line 190.

In an exemplary embodiment the chamber 110 can have a hollow cylinder shape or a hollow box shape. The chamber 110 has a space in which various unit processes for manufacturing a semiconductor device can be performed on one or more wafers W. In an exemplary embodiment, the unit processes may include a deposition process for forming a layer on the wafers W, a curing process for curing the layer on the wafers W, a baking process for hardening a photoresist layer on the wafers W and an etching process for etching the layer on the wafers W.

The boat 120 is positioned in the chamber 110 and one or more wafers W are separately stacked along a vertical direction in the boat 120. The boat 120 includes a first plate 122, a second plate 124 and a plurality of supporting bars 126. The first plate 122 and the second plate 124 have a circular shape. In an exemplary embodiment three or four supporting bars 126 are interposed between the first plate 122 and the second plate 124.

The first plate 122 and the second plate 124 have substantially the same diameter. In cue exemplary embodiment, the first and second plates 122, 124 are positioned at top and bottom portions of the boat 120, respectively, and the diameters of the first and second plates 122, 124 are substantially larger than that of the water W. Therefore, the wafers W can be sufficiently stacked in an inner space of the boat 120 defined by the first and second plates 122, 124. The first plate 122 has a first opening 123 passing through a central portion of the first plate 122.

The supporting bars 126 are arranged along an edge portion of the first plate 122 and the second plate 124. In an exemplary embodiment, when a virtual circle of which the diameter is the same as that of the wafer W is interposed between the first plate 122 and the second plate 124 concentrically with the wafer W, the supporting bars 126 are arranged along a circumferential line of the virtual circle and both end portions of each supporting bar 126 make contact with the first and second plates 122, 124, respectively. In an exemplary embodiment, the center of each supporting bar 126 coincides with the circumferential line of the virtual circle, and thus, the edge portion of the wafer W makes contact with a semicircular surface of the circular-shaped supporting bar 126 in the boat 120 when the wafers are stacked substantially parallel with the virtual circle in the boat 120. That is, each of the wafers W is supported on a half portion of the cross-sectional surface of the supporting bars 126 in the boat 120.

Each of the supporting bars 126 has a plurality of slots 127. The slots 127 are disposed along a longitudinal direction of the supporting bars 126 at substantially uniform intervals. The wafers W are inserted into the slots 127 substantially parallel with the first and the second plates 122, 124.

The wafers W may include materials sensitive to microwaves. In exemplary embodiments, the materials may include polymer, doped silicon, and the like.

The chamber 110 has an opening at a lower portion thereof. The boat 120 can be moved into and out of the chamber 110 through the opening.

The reflective plates 130 are inserted into the slots 127 of the supporting bars 126 in such a configuration that a single reflective plate 130 is positioned over the wafer W and faces the same side surface of the respective wafer W. In an exemplary embodiment, the reflective plates 130 have inclined surface portions that face an upper surface of the wafer W, respectively, as illustrated in FIG. 1. Alternatively, the inclined surface portions of reflective plates 130 may face a lower surface of the wafer W, respectively. A first surface of the reflective plate 130 is flat and is substantially parallel with the first or the second plate 122, 124, and a second surface opposite to the first portion of the reflective plate 130 is convex toward the upper surface of the wafer W.

The reflective plate 130 positioned over the uppermost wafer W has a second to opening 136 at a central portion thereof.

The microwaves for heating the wafers W are generated from the microwave generators 150 that are arranged at a lateral portion of the boat 120, and, in an exemplary embodiment, substantially parallel to the wafers W mounted in boat 120. Thus, the microwaves are directly applied to the edge portion of the wafers in the boat 120 and are sufficiently reflected from the inclined convex surface of the reflective plate 130 toward the central portion of the wafer W within each slit space of the boat 120. Therefore, the microwaves can be sufficiently applied to the central portion of the wafers W as well as the edge portion of the wafers W, and thus the temperature difference between the central portion and the edge portion of the wafer W can be minimized to thereby improve temperature uniformity of the wafer W. In an exemplary embodiment, the reflective plate 130 may include a metal having good reflectivity such as steel, copper, aluminum, and the like.

When the diameter of each reflective plate 130 is much smaller than that of each wafer W, the microwaves minimally reach to the reflective plate 130 between the wafers W. Hence, the microwaves are sufficiently applied to the edge portion or each wafer W and are minimally applied to the center portions of each wafer W.

When the diameter of each reflective plate 130 is equal to or much larger than that of each wafer W, the microwaves easily reach to the reflective plate 130 between the wafers W. Therefore, the microwaves are reflected by the reflective plates 130, and thus the microwaves can be sufficiently applied to the central portion of the wafers W as well as the edge portions of the wafers W.

Accordingly, in an exemplary embodiment the diameter of each reflective plate 130 is substantially larger than or substantially equal to the diameter of each wafer W.

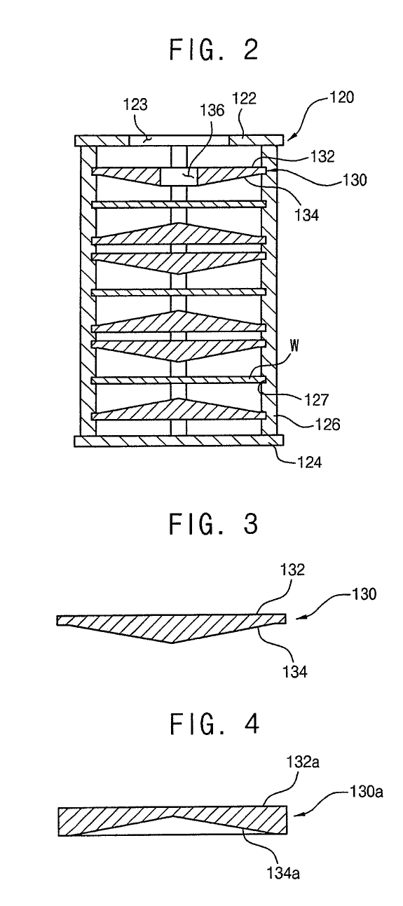

FIG. 2 is a partially enlarged view illustrating a modified exemplary embodiment of the boat of the process apparatus illustrated in FIG. 1. In FIG. 2, the modification involves the arrangement of the reflective plates.

Referring to FIG. 2, the reflective plates 130 are disposed in the slots 127 of the supporting bars 126 to face both sides of the each wafer W. In an exemplary embodiment, the reflective plates 130 are respectively disposed to the upper side and the lower side of each wafer W. One reflective plate 130 is positioned over the uppermost wafer and another reflective plate 130 is positioned under the bottommost wafer in such a configuration that the convex portion of the reflective plate 130 faces an upper surface of the uppermost wafer and a lower surface of the bottommost wafer, respectively. A pair of the reflective plates is interposed between the interior wafer situated between the uppermost wafer and the bottommost wafer in such a configuration that both the upper surface and the lower surface of the middle wafer faces the convex portions of the reflection plates 130. Accordingly, the microwaves can be sufficiently applied to both the central portions of the lower surface of the middle wafer as well as of the central portions of the upper surface of the middle wafers. Those skilled in the art can appreciate that a plurality of middle wafers and their respective reflection plates can be similarly situated between the uppermost and bottommost wafers.

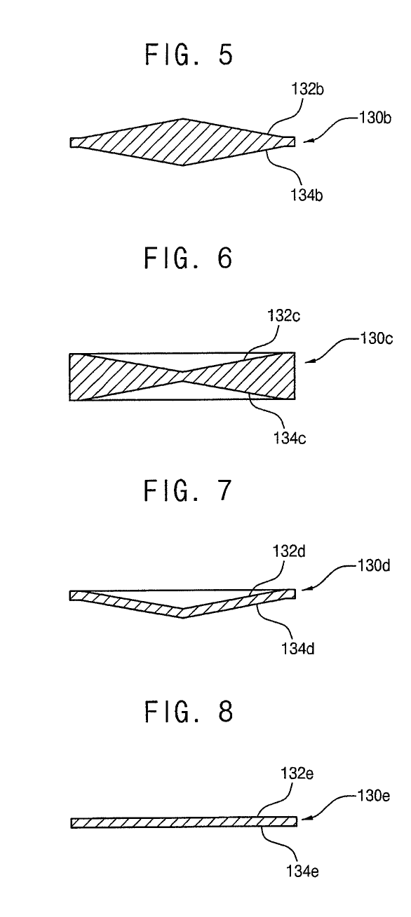

FIGS. 3 to 8 are cross-sectional views illustrating various reflective plates in accordance with exemplary embodiments of the present invention.

Referring to FIG. 3, a first side 132 of the reflective plate 130 is flat and a second side 134 opposite to the first portion of the reflective plate 130 is convex.

Referring to FIG. 4, the first side 132a of the reflective plate 130a is flat and the second side 134a of the reflective plate 130a is concave.

Referring to FIG. 5, both the first and second sides 132b, 134b of the reflective plate 130b is convex.

Referring to FIG. 6, both the first and second sides 132c, 134c of the reflective plate 130c is concave.

Referring to FIG. 7, the first side 132d of the reflective plate 130d is concave and the second side 134d of the reflective plate 130d is convex.

Referring to FIG. 8, the first and second sides 132e, 134e of the reflective plate 130 are flat.

In FIGS. 1 to 7, the convex and concave portions of the reflective plates 130, 130a, 130b, 130c, 130d, may have a hemisphere shape, a cone shape, a pyramid shape, a truncated cone shape, a truncated pyramid shape, and the like. Both the first and second sides of the reflective plates as illustrated in FIGS. 1 to 8 are smooth. Alternatively, both the first and second sides of the reflective plate 130, 130a, 130b, 130c, 130d, 130e, may be rough and include a plurality of recesses and/or protrusions.

Also, those skilled in the art can appreciate that embodiments of the reflective plates 130, 130a, 130b, 130c, 130d, 130e can have other perimeter shapes, such as squares, triangles, and the like, provided that their innermost extremities are at least as large as the diameter of each wafer W.

Referring back to FIG. 1, the driving unit 140 is connected to the boat 120. The driving unit includes a first motor 142, a second motor 144, and a third motor 146.

The first motor 142 rotates the boat 120 about a longitudinal central axis of the boat 120. The second motor 144 moves the boat 130 in a vertical direction substantially perpendicular to the first and second plates 122, 124 of the boat 130. The third motor 146 moves the boat 120 in the horizontal direction substantially parallel to the first and second plates 122, 124 of the boat 130. The wafers W and the reflective plates 130 in the boat 120 are collectively rotated and moved in the vertical and the horizontal direction in conjunction with the rotation and the linear movement of the boat 120 by the driving unit 140. Since positions of the wafers W and the reflective plates 130 can be varied, the microwaves can be applied more uniformly to the wafers W.

In accordance with an exemplary embodiment, the reflective plates 130 can be supported by an additional supporting member (not illustrated) in the boat 120 in place of the slots 127 of the supporting bars 126 in such a configuration that at least one reflective plate 130 is positioned above and/or below the wafer W. Further, an additional driving unit (not shown) can be installed in the process apparatus 100 for rotating and linearly moving the additional supporting member. The driving unit 140 and the additional driving unit may function independently from each other and thus the reflective plates 130 and the additional supporting member can experience a relative motion with each other. Accordingly, the microwaves can be supplied uniformly to the wafers W.

In accordance with an exemplary embodiment, the reflective plates 130 may be arranged on an inner wall of the chamber 110, and thus the microwaves may be efficiently reflected from the inner wall of the chamber 110 toward the wafers W in the boat 120, to thereby improve heating efficiency in the process apparatus 100. In an exemplary embodiment, the process apparatus 100 may further include a further additional motor (not illustrated) to control a reflection angle of the reflective plates 130.

At least two microwave generators 150 are installed at different positions around the chamber 110. The microwave generators 150 generate the microwaves and the microwaves propagate into the chamber 110 in a propagation direction substantially parallel to or inclined to the wafers W. The microwaves are directly applied to the wafers W and/or reflected from the reflective plate 130 to the wafers W in the boat 120, and thus the wafer W can be heated to a uniform temperature across the entire surface in the chamber 110. In an exemplary embodiment, the microwave generators 150 may include a magnetron, a traveling-wave tube, a klystron, and the like.

The number and the position of the microwave generators 150 can be varied in view of uniform heating to the wafer W and can be determined by repeated experiments and/or a computer simulation.

Each of the microwaves generated from the microwave generators 150 generate electromagnetic fields in the chamber 110, respectively. At least two electromagnetic fields may be superposed with each other to generate another electromagnetic field.

The power supplies 160 are respectively connected to the microwave generators 150. The power supplies 160 provide energy for operating the microwave generators 150.

The sensor 170 is disposed on an upper portion in the chamber 110. The sensor 170 detect the temperature of the central portion of the uppermost wafer W through the first opening 123 of the first plate 122 and the second opening 136 of the reflective plate 130.

The controller 170 is connected to the power supplies 160. The controller 170 turns on or off the power supplies 160 to thereby control output power of the power supplies 160.

The amount of the microwaves propagating into the chamber 110 can be determined in accordance with the turning on and off of the power supplies 160, and the intensity of the microwaves can be varied according to the output power of the power supplies 160. Accordingly, the physical properties of the superposed electromagnetic fields in the chamber 110 can be varied in accordance with the amount and the intensity of the microwaves generated from the generators 150. Since the superposed electromagnetic fields in the chamber 110 can be quickly varied, the microwaves can be propagated uniformly to various points of the chamber 110 during a predetermined time. Therefore, the microwaves can uniformly heat each wafer W.

In addition, the wafers W are rotated and moved in the vertical and the horizontal directions in accordance with the rotation and the movement in the vertical and the horizontal directions of the boat such that the microwaves can respectively heat the wafers W more uniformly.

The controller 180 is connected to the sensor 170. The controller 180 controls the on/off and the power intensity of the power supplies 160 according to the temperature of the wafer W measured by the sensor 170. In an exemplary embodiment, the controller 180 can maintain the temperature of the uppermost wafer W as a reference temperature. When the temperature measured by the sensor 170 is substantially lower than the reference temperature, the controller 180 controls the power supplies 160 to be turned on for heating the wafers W. When the temperature measured by the sensor 170 is equal to the reference temperature, the controller 180 controls the output power of the power supplies 160 for keeping the temperature of the wafers W constant. When the temperature measured by the sensor 170 is substantially higher than the reference temperature, the controller 180 controls the power supplies 160 to be off for cooling the wafers W.

In an exemplary embodiment, the controller 180 controls the turning on and off and the intensity of the power supplies 160 by keeping a total sum of the output power of the power supplies 160 constant. Here, the controller 180 has no relation with the temperature measured by the sensor 170.

According to an exemplary embodiment, the controller 180 can control the turning on and off and the intensity of the power supplies 160 according to the temperature measured by the sensor 170. Here, the total sum of output power of the power supplies 160 is not constant.

According to an exemplary embodiment, the controller 180 can control the turning on and off and the intensity of the power supplies 160 by keeping the total sum of the output power of the power supplies 160 constant according to the temperature measured by the sensor 170.

According to an exemplary embodiment, the controller 180 can be configured to control both the turning on and off and the intensity of the power supplies 160 and the movement of the wafers W and the reflective plates 130 as directed by the driving unit 140.

The gas supply line 190 is connected to the chamber 110. The gas supply line 190 supplies process gases for processing the wafers W in the chamber 110. In an exemplary, embodiment, the process gases may include deposition gases for forming a layer on the wafers W, etching gases for removing the layer from the wafers W, and the like.

When the deposition process or the etching process is performed in the chamber 110, the process gases are supplied into the chamber 110 through the gas supply line 190. When the curing process or the baking process is performed in the chamber 110, the supply of the process gases through the gas supply line 190 is stopped.

Hereinafter, an operating method of the apparatus 100 will be described in more detail.

In an exemplary embodiment the reflective plates 130 are stacked along the vertical direction at uniform intervals in the boat 120. The wafers W may be also stacked along the vertical direction in the boat 120 in such a configuration that each wafer W is disposed between the reflective plates 130. When the reflective plates 130 and the wafers W are stacked in the boat 130, the boat 120 is inserted into the chamber 110 through the opening at the lower portion thereof. Then, the boat 120 is rotated and moved in the vertical and the horizontal directions by the driving unit 140.

When the boat 120 rotates and moves in the vertical and the horizontal directions, the controller 180 controls the power supplies 160 such that the microwave generators 150 generate the microwaves.

According to an exemplary embodiment, the controller 180 controls the turning on and off and the intensity of the power supplies 160 by keeping the total sum of the output power of the power supplies 160 constant. Here, the controller 180 has no relation with the temperature measured by the sensor 170.

According to an exemplary embodiment, the controller 180 controls the turning on and off and the intensity of the power supplies 160 according to the temperature measured by the sensor 170. Here, the total sum of the output power of the power supplies 160 is not constant.

According to an exemplary embodiment, the controller 180 controls the turning on and off and the intensity of the power supplies 160 by keeping the total sum of the output power of the power supplies 160 constant according to the temperature measured by the sensor 170.

The power supplies 160 can be quickly turned on or off, and the intensity of the microwaves can be rapidly varied by the controller 180. The microwaves can be directly applied to the wafers W and/or can be reflected from the reflective plate 130 to the wafers W in the boat 120. Hence, the microwaves can be applied uniformly to each wafer W and each point of each wafer W. Accordingly, the wafer W can be heated to a uniform temperature across the entire surface in the chamber 110.

The curing process for curing the layer on the wafer W and the baking process for hardening the photoresist layer on the wafer W can be performed by healing the wafers W.

Since the wafer W are uniformly heated in the process apparatus 100, a process temperature can be reduced and a process time can be shortened in the curing process and the baking process for heating the Wafers W. Therefore, the efficiency of the curing process and the baking process can be improved.

When the wafers W are sufficiently heated by the microwaves, the process gases are supplied into the chamber 110 through the gas supply line 190 to perform the deposition process and the etching process.

According to an exemplary embodiment, the apparatus varies the on/off and the output power of the power supplies to control the generation and intensity of the microwaves. The microwaves are uniformly supplied to each wafer during a predetermined time by controlling the generation and intensity of the microwaves. In addition, the apparatus uniformly supplies the microwaves to each part of the wafer using the reflective plates disposed between the wafers. Therefore, the wafers can be uniformly heated.

The apparatus can rotate the wafers and the reflective plates, and can move the wafers and the reflective plates in vertical and horizontal directions. Therefore, the wafers can be uniformly heated and processed.

Since the wafers can be uniformly heated, the process temperature of a wafer heating process can be lower and the process time of the wafer heating process can be reduced. Therefore, the efficiency of a curing process and a baking process is improved. The foregoing is illustrative of exemplary embodiments and is not to be construed as limiting thereof. Although several practical exemplary embodiment have been described, those skilled in the art will readily appreciate that many modifications are possible. Accordingly, the exemplary embodiments disclosed and all such modifications thereto are intended to be included within the scope of the invention as defined in the claims.

What is claimed is:

1. An apparatus for processing a wafer, comprising:
a chamber;
a boat in the chamber, a plurality of the wafers being stackable in the boat;
a plurality of microwave generators connected to the chamber, the microwave generators configured to generate microwaves that heat the wafers; and
a plurality of reflective plates from which the microwaves are reflected onto the wafers such that the microwaves are uniformly applied to the wafers.

2. The apparatus of claim 1, wherein each of the reflective plates faces at least one of both sides of the wafer.

3. The apparatus of claim 1, wherein the reflective plates includes at least one of a flat side, a concave side or a convex side.

4. The apparatus of claim 1, wherein a diameter of the reflective plate is greater than or equal to a diameter of the wafer.

5. The apparatus of claim 1, further comprising:
a plurality of power supplies connected to the generators, respectively, that supply output power to the microwave generator; and
a controller connected to the power supplies that controls generation of the microwaves by turning on or off the power supplies and that controls wave intensity of the microwaves by varying the output power of the power supplies, such that the microwaves are uniformly applied to the wafer.

6. The apparatus of claim 5, further comprising a temperature sensor positioned at an upper portion of an inside of the chamber and connected to the controller, such that a temperature of the wafer is detected through a hole penetrating a central portion of an uppermost reflective plate by the temperature sensor and the controller controls the power supplies in accordance with the detected temperature of the wafer.

7. The apparatus of claim 5, wherein the controller maintains a total sum of the output power of the power supplies to be constant.

8. The apparatus of claim 1, further comprising a driving unit connected to the boat and including a motor for rotating the boat and for linearly moving the boat in a vertical direction and in a horizontal direction.

9. The apparatus of claim 1, further comprising a gas supply line connected to the chamber, the gas supply line supplying a processing gas for processing the wafers in the chamber.

10. The apparatus of claim 9, wherein the processing gas includes one of a deposition gas for forming a layer on the wafer and an etching gas for removing a layer from the wafer.

11. A wafer heating apparatus comprising:
a wafer support structure configured to align one or more wafers substantially parallel to a microwave propagation direction from one or more microwave generators; and
a reflective plate located adjacent to at least one wafer of the one or more wafers, the reflective plate having a surface configured to redirect to an interior portion of the at least one wafer microwaves that are generated from the one or more microwave generators and that are incident upon the reflective plate.

12. The wafer heating apparatus of claim 11, wherein the reflective plate comprises:
a first surface proximal to a wafer surface of the at least one wafer; and
a second surface distal from the wafer surface,
wherein the first surface is convex relative to the wafer surface and the second surface is substantially parallel to the wafer surface.

13. The wafer heating apparatus or claim 11, wherein the reflective plate comprises:
a first surface proximal to a wafer surface of the at least one wafer; and
a second surface distal from the wafer surface,
wherein the first surface is concave relative to the wafer surface and the second surface is substantially parallel to the wafer surface.

14. The wafer heating apparatus of claim 11, wherein the reflective plate comprises:
a first surface proximal to a wafer surface of the at least one wafer; and
a second surface distal from the wafer surface,
wherein both the first surface and the second surface are convex relative to the wafer surface.

15. The wafer heating apparatus of claim 11, wherein the reflective plate comprises:
a first surface proximal to a wafer surface of the at least one wafer; and
a second surface distal from the wafer surface,
wherein both the first surface and the second surface are concave relative to the wafer surface.

16. The wafer heating apparatus of claim 11, wherein:
the at least one wafer includes a first wafer surface and a second wafer surface opposing the first wafer surface,
the reflective plate is adjacent the first wafer surface; and
a second reflective plate, having a surface configured to redirect to an interior portion of the at least one wafer microwaves incident upon the second reflective plate that are generated from the one or more microwave generators and that are incident upon the second reflective plate, is adjacent the second wafer surface.

17. The wafer heating apparatus of claim 11, wherein the wafer support structure comprises a plurality of support members substantially parallel to an axis of the at least one wafer, the support members being separated from each other such that the microwaves propagate from the microwave generators into a separation area between at least one pair of adjacent support members.

18. The wafer heating apparatus of claim 17, wherein each of the support members includes a notch into which an edge of the at least one wafer is disposed.

19. The wafer heating apparatus of claim 17, further comprising:
an end plate coupled to an edge of the support members; and
a drive unit coupled to the end plate, the drive unit comprising one or more motors configured to move the one or more wafers in a plurality of directions relative to the microwave propagation direction.

20. The wafer heating apparatus of claim 19, further comprising:
a controller that controls the driving unit and/or the one or more microwave generators; and
a sensor disposed proximal to one wafer of the at least one or more wafers and configured to provide temperature data of the one wafer to the controller for moving the at least one or more wafers and/or for regulating an amount of power generated from the one or more microwave generators.
